(19) United States
(12) Patent Application Publication
(10) Pub. No.: US 2022/0183420 A1
(43) Pub. Date: Jun. 16, 2022

(54) COUPLING ELEMENT AND SPORTS SHOE HAVING SUCH A COUPLING ELEMENT

(71) Applicant: Dieter Schillinger, Messstetten (DE)

(72) Inventor: Dieter Schillinger, Messstetten (DE)

(21) Appl. No.: 17/582,804

(22) Filed: Jan. 24, 2022

Related U.S. Application Data
(63) Continuation of application No. PCT/DE2020/100733, filed on Aug. 21, 2020.

(30) Foreign Application Priority Data
Sep. 4, 2019 (DE) 102019123639.8

(51) Int. Cl. A43B 13/14; A43B 5/14

(52) U.S. Cl. CPC A43B 13/14; A43B 5/14

(57) ABSTRACT

A coupling element configured to connect an athletic shoe with a piece of sports equipment, the coupling element including a cleat configured to engage the piece of sports equipment and disengage from the piece of sports equipment; at least one fastener configured to fasten the cleat at a reaction bearing arranged in a sole of the athletic shoe, wherein the cleat includes exactly one rotation symmetrical pass through opening configured to receive the at least one fastener, wherein the exactly one rotation symmetrical pass-through opening includes at least one concentric shoulder that cooperates with an eccentrical rotatable element that is inserted in the pass-through opening in a form locking manner, includes a recess configured to receive the at least one concentric shoulder in a form locking manner, and that terminates flush with a surface of the cleat.

### RELATED APPLICATIONS

This application is a continuation of International Patent Application PCT/DE2020/100733 filed on Aug. 21, 2020 claiming priority from German Patent Application DE 10 2019 123 639.8 filed Sep. 4, 2019, both of which are incorporated in their entirety by this reference.

### FIELD OF THE INVENTION

The invention relates to a coupling element configured to connect an athletic shoe with a piece of sports equipment, the coupling element including a cleat configured to interlock at the piece of sports equipment in a disengageable manner, and fasteners configured to attach the cleat at a reaction bearing arranged in a sole of the athletic shoe, wherein the cleat includes exactly one pass through opening configured to receive a fastener wherein the pass-through opening is rotation symmetrical. The invention also relates to an athletic shoe including the coupling element.

### BACKGROUND OF THE INVENTION

A generic coupling element is known from U.S. Pat. No. 4,377,952 A. This document discloses a cleat that is rotatable about an attachment bolt and that engages a reaction bearing that is arranged in the athletic shoe longitudinally movable. This way an angle as well as a position of the cleat under the sole of the athletic shoe can be controlled, wherein linear displacement can only be performed along a groove in the shoe sole.

Cleats are well known in the art e.g. from DE 40 40 728 A1 This document describes a coupling element that can be mounted at different points below a sole of an athletic shoe. Typically, various components of the coupling element are assembled and a thread is started in order to be able to roughly align the coupling element. Only when the desired position is reached, possibly by using suitable alignment devices the coupling element is bolted down and ready for use.

Thus, the precise positioning can be adjusted in two ways. The major adjustment option comes from the cleat being attached at the sole by two bolts, wherein a reaction bearing is loosely supported at an inside of the shoe like the cleat itself in the prior art. The connection between the reaction bearing and the cleat is provided by two parallel slotted holes which are configured to adjust a longitudinal position of the coupling element. During adjustment the reaction bearing slides back and forth. As soon as the fasteners like e.g: bolts are tightened the cleat and the reaction bearing engage the sole material with an interlocking profile so that they are fixed. A cross rail is achieved in this solution by a sliding element that is laterally supported so that the cleat can also be laterally moved relative to the fasteners.

The second method of adjustment is based on the pass-through openings being arranged with the considerable clearance so that a slanted arrangement can be achieved to some degree.

This solution, however, has a substantial disadvantage. Under adverse weather conditions like rain or snow moisture can penetrate through the slotted holes which largely remain open in any position of the coupling element at the shoe sole. Making a step into slush which adheres to the bottom of the shoe allows moisture and cold temperature to penetrate through the slotted holes into the shoe. This can be counteracted to some extent with a sole insert, however, the sole insert will be soaked after a short time period which only makes the problem worse since the sole insert acts as a cooling element.

The metal material of the cleat which is connected by metal fasteners at a metal reaction bearing generates a cold bridge due to the material and a user loses a large amount of body heat to the ambient through the cold bridge. A similar solution is known from DE 42 01 916 A1 or US 2014/0259796 A1.

Many other solutions are known in the art where cleats are attached at a sole of an athletic shoe by two point or three-point attachment. Thus, EP 1 293 424 A2 discloses a solution with two bolts arranged behind one another, wherein the bolts are supported in slotted holes which facilitate an angle adjustment but no linear displacement in a forward or backward direction.

EP 1 442 670 A1 solves the problem with a reaction bearing with three bolting points wherein the reaction bearing is received in a form locking manner on an inside of the sole. An adjustment of the position of the cleat relative to the shoe sole can thus not be performed.

A coupling element is attached in EP 2 238 849 A1 in a similar manner. Thus, slotted holes are associated with the cleat itself which still facilitate a displacement of the cleat in defined local receivers. A rotation or a lateral offset can only be provided to a very limited extent. This applies analogously also to WO 2013/077912, JPH 4-117902 A or U.S. Pat. No. 4,876,908A. WO 97/09228 uses rotatable eccentrical washers.

WO 88/06315 A1 provides a bolted connection at three points through curved slotted holes. The curved slotted holes facilitate a rotation but no forward or backward linear displacement.

WO 2016/041021 A2 facilitates a slanted arrangement using a three-point bolted connection with slotted holes in combination with supporting the cleats with wedge shaped spacers.

The U.S. documents U.S. Pat. Nos. 4,907,469 A; 5,079,968 A; 5,199,192 A; US 2012/066935 A1 and US 2012/227287 A1 provide additional three-point bolted connections, partially with slotted holes, wherein the threaded connection is provided in a fixed reaction bearing. WO 87/07120 A1 provides an attachment with a bolt and two attachment clamps.

All these solutions show that improving sealing properties of the shoe goes hand in hand with limitations with respect to position adjustability. A bolted connection that provides a tight seal reduces adjustability of the cleats.

### BRIEF SUMMARY OF THE INVENTION

Improving upon the art recited supra, it is an object of the invention to provide a coupling element and an athletic shoe with the coupling element which combine good sealing properties and good insulation properties with a high level of flexibility for positioning and orienting the cleat at the sole.

The object is achieved by a coupling element configured to connect an athletic shoe with a piece of sports equipment, the coupling element including a cleat configured to engage the piece of sports equipment and disengage from the piece of sports equipment; at least one fastener configured to fasten the cleat at a reaction bearing arranged in a sole of the athletic shoe, wherein the cleat includes exactly one rotation symmetrical pass through opening configured to receive the at least one fastener, wherein the exactly one rotation symmetrical pass-through opening includes at least one concentric shoulder that cooperates with an eccentrical rotatable element that is inserted in the pass-through opening in a form locking manner, includes a recess configured to receive the at least one concentric shoulder in a form locking manner, and that terminates flush with a surface of the cleat, wherein the at least one fastener includes exactly one fastening bolt that includes a head that terminates flush with the surface of the cleat in an operating condition.

The object is achieved by a coupling element configured to connect an athletic shoe with a piece of sports equipment, the coupling element including a cleat configured to engage the piece of sports equipment and disengage from the piece of sports equipment; at least one fastener configured to fasten the cleat at a reaction bearing arranged in a sole of the athletic shoe, wherein the cleat includes exactly one rotation symmetrical pass through opening configured to receive the at least one fastener, wherein the exactly one rotation symmetrical pass-through opening includes at least one concentric shoulder that cooperates with an eccentrical rotatable element that is inserted in the pass-through opening in a form locking manner, includes a recess configured to receive the at least one concentric shoulder in a form locking manner, and that terminates flush with a surface of the cleat, wherein the eccentrical rotatable element includes a longitudinal slot arranged above the recess and configured to receive a sliding plate, and wherein the eccentrical rotatable element includes a half open or closed slotted hole in a plane of the recess wherein edges of the half open or closed slotted hole protrude relative to lateral walls of the longitudinal slot.

The object is also achieved by A coupling element configured to connect an athletic shoe with a piece of sports equipment, the coupling element including a cleat configured to engage the piece of sports equipment and disengage from the piece of sports equipment; at least one fastener configured to fasten the cleat at a reaction bearing arranged in a sole of the athletic shoe, wherein the cleat includes exactly one rotation symmetrical pass through opening configured to receive the at least one fastener, wherein the exactly one rotation symmetrical pass-through opening includes at least one concentric shoulder that cooperates with an eccentrical rotatable element that is inserted in the pass-through opening in a form locking manner, includes a recess configured to receive the at least one concentric shoulder in a form locking manner, and that terminates flush with a surface of the cleat, wherein the eccentrical rotatable element includes a receiver for a circular sliding plate above the recess, and wherein the receiver is circular and eccentrical with respect to the eccentrical rotatable element and at least partially enveloped by a circular segment shaped wall.

The object is also achieved by an athletic shoe including one of the coupling elements recited supra; a sole; and a reaction bearing associated with the sole and including at least one receiver configured for form locking reception of a shaft of the at least one fastener.

According to the invention the coupling element includes a cleat which is configured to engage an interlocking connection due to a shape and position of the cleat so that an athletic shoe where the cleat is attached is connectable to a piece of exercise equipment by the cleat. The piece of exercise equipment can be advantageously configured as a bicycle where pedals can be engaged by the cleats of two athletic shoes. The coupling element according to the invention is also usable in other pieces of sporting equipment e.g. skis, surf boards and similar. The description focuses subsequently on bicycles or however other pieces of sporting equipment are within the spirit and scope of the invention.

The cleat according to the invention is configured to cooperate with a reaction bearing that is attached at the athletic shoe. In order to achieve a maximum amount of flexibility the cleat includes exactly one rotation symmetrical pass-through opening which facilitates fixing fasteners in the reaction bearing of the athletic shoe. Thus, the cleat is freely rotatable about the fastener so that it can be oriented in every angle. There is no limitation by a predetermined clearance which would only degrade the attachment. Rather the cleat is freely alignable while maintaining full engagement of the fastener.

A rotation symmetrical pass-through opening can be circular, however, also other shapes are included like octagonal or polygonal, cross shaped or star shaped pass-through openings. Thus, the pass-through opening can be arranged in a center of gravity of the cleat so that a retaining force is centrally applied and has the same strength in all directions.

In order to further increase flexibility of the attachment the pass-through opening can have a concentric shoulder that is contacted by an eccentrical rotatable element that is adapted to a shape of the pass-through opening wherein the eccentrical rotatable element is rotatably supported in the pass-through opening. A circular eccentrical rotatable element is freely rotatable in a circular pass-through opening, a multi-edge eccentrical rotatable element is incrementally displaceable in a multi-edge pass-through opening and so forth. Thus, an eccentrically arranged pass-through opening of the rotatable eccentrical element can be moved into different positions depending on its rotational position so that an overall position of the coupling element is movable about the fasteners as a function of a rotational position of the eccentrical pass-through opening. Due to the shoulder configuration the rotatable element can be received flush in the cleat without protruding beyond a surface of the cleat. Flush in this context specifically includes that the rotatable element can be configured lower than a surface of the cleat.

Additional flexibility can be achieved when the eccentrical rotatable element forms a longitudinal slot above the recess in the shoulder wherein the fastener is not only supported in an eccentrical position with respect to the eccentrical rotatable element but is also movable from a center position into an eccentrical position. This can be implemented by configuring the pass-through opening of the eccentrical rotatable element in a plane of the recess as a semi-open or closed slotted hole whose edges protrude relative to the walls of the slotted hole. This provides anchoring means in the slotted hole wherein the fasteners can in turn be inserted flush with the cleat.

Furthermore, a sliding element can be inserted into the slotted hole in order to provide defined positioning for the fastener, wherein the sliding element functions as a slide for the fasteners. The sliding element is advantageously configured as a plate that is displaceable in the slotted hole wherein outer contours of the plate run in parallel in the longitudinal direction and can slide in the longitudinal slot and form the inner contour of the pass-through opening in the transversal direction. A pass-through opening of the sliding element can be advantageously configured eccentrical and can be aligned in the longitudinal direction of the sliding element with the slotted hole of the eccentrical rotatable element.

Advantageously the fasteners include exactly one fastening bolt wherein a shaft of the fastening bolt engages a receiver at a reaction bearing of an athletic shoe while a head of the fastening bolt is received flush in the pass-through opening of the cleat. The fastener is advantageously configured as a threaded bolt, bolt or similar.

This arrangement yields maximum flexibility for adjusting the coupling element which is movable into any position and angular orientation through an eccentrical or centric rotation of the cleat about a receiver of the reaction bearing due to the sliding element enabling a polar displacement about the receiver. Simultaneously the coupling element can be fixed at an athletic shoe reliably by its centrally arranged fasteners.

An athletic show provided with the coupling element described supra includes a reaction bearing at its sole wherein the reaction bearing includes one or plural receivers for form locking reception of the shaft of the fastener, in particular of a fastening bolt. Arranging plural receivers that are offset relative to each other facilitates significantly enlarging a positioning circle that is reachable by the coupling element.

The receivers providing a form locking engagement of the fasteners mitigates a penetration of water, snow, slush and cold air contrary to the art cited supra. Thus, an athletic shoe according to the invention will be accessible only through one or plural typically circular receivers configured as circular bore holes from a bottom side instead of being accessible through slotted holes like in the art recited supra.

Unused receivers can be advantageously provided with a sealant that seals and closes the unused receivers. Set screws can be used for this purpose that can be made from an insulating material which in turn closes the thread turns water tight and which in turn does not function as a cold bridge itself. This material can also be suitable for the fasteners and the reaction bearing itself.

The fasteners are connected with a reaction bearing that is associated with the athletic shoe, thus the sole of the athletic shoe. The reaction bearing can be inserted into the sole advantageously form locking through openings in the sole in an internal recess in the sole material or the reaction bearing can be directly embedded into the material of the sole, e.g. encased by the sole material through injection molding.

In an advantageous embodiment of the athletic shoe the sole includes conical protrusions about the receivers of the reaction bearing which facilitate a conical contact area of the cleat on the sole. A solution of this type can also be used in all centrally attached prior art coupling elements independently from a particular shape of the coupling element. Thus, a center of the cleat contacts the tip of the cone and seals well about the receiver centrally arranged in the cone which further improves the alignment of the coupling element. This compensates for different engagement depths caused by a clamboltg force that engages eccentrically relative to a cleat axis, in particular during a tilting about longitudinal axis of the shoe and improves alignment of the cleat with respect to a contact plane of the shoe sole.

### BRIEF DESCRIPTION OF THE DRAWINGS

The invention is subsequently described based on embodiments with reference to drawing figures, wherein:

FIG. 1 illustrates a sole of an athletic shoe with a prior art coupling element in a perspective view;

FIG. 2 illustrates a detail of the prior art coupling element according to FIG. 1 in a perspective view;

FIG. 3 illustrates a sole of an athletic shoe with a coupling element according to the invention in a perspective view;

FIG. 4 illustrates the coupling element according to the invention showing a detail of FIG. 3 in a perspective view:

FIG. 5 illustrates the sole of the athletic shoe according to FIG. 3 in a partial sectional view of the sole including a perspective exploded view of the coupling element according to the invention; and

FIG. 6 illustrates a lateral cross-sectional view of the sole according to an embodiment of the invention including a conical protrusion.

### DETAILED DESCRIPTION OF THE INVENTION

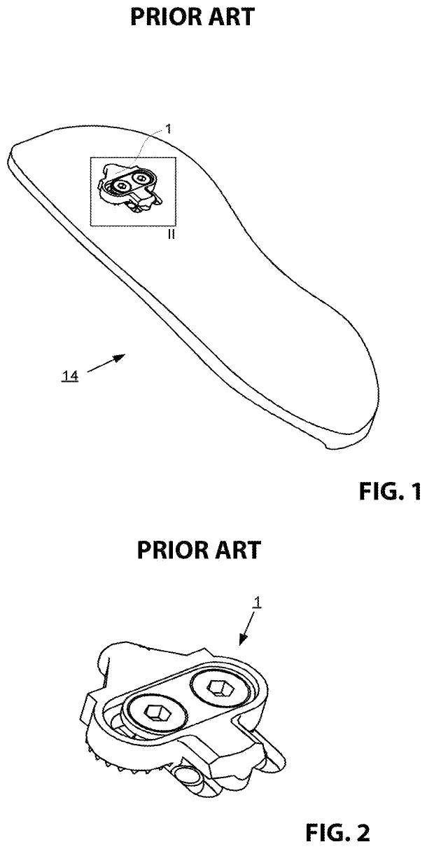

FIG. 1 illustrates a sole of an athletic shoe, in particular a cycling shoe that is known in the art. The sole 14 includes a coupling element 1 enabling a wearer of the shoe to interlock with the sole 14 in a bicycle pedal so that the wearer is comfortably and directly connected with pedals of the bicycle. Thus. FIG. 2 illustrates the coupling element 1 in detail showing that the coupling element 1 is supported in this case in two slotted holes that are introduced into the sole. Two bolts engage the slotted holes that cooperate with a reaction bearing beyond the slotted holes. A linear displacement along the slotted holes and a transversal displacement of the two bolts in the illustrated cleat implements a cross rail which also facilitates an angular orientation due to a certain amount of clearance. One the one hand side, the degrees of freedom of the arrangement are limited. On the other hand, side moisture and cold can enter an interior of the shoe through the slotted holes.

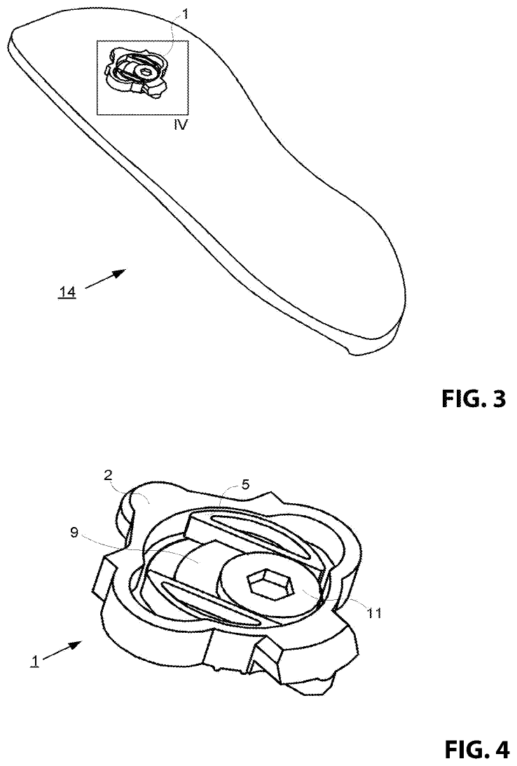

FIG. 3 illustrates a sole 14 according to the instant invention that includes a coupling element 1 according to the invention. In order to achieve a coupling at identical pedals, the coupling element 1 includes identical outer contours, the inner contour, however, is configured totally different. In particular only a single attachment bolt is provided to facilitate a polar eccentrical displacement of the coupling element 1. FIGS. 3 and 4 illustrate a displacement of the coupling element 1 into a left upper position in FIG. 3. From a wearers point of view this corresponds to a right forward position under the foot.

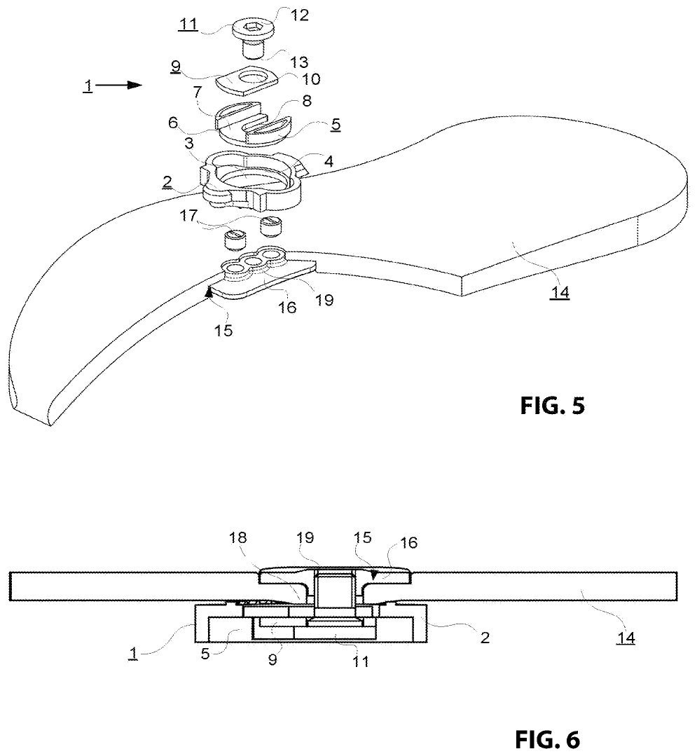

FIG. 5 illustrates the configuration of the coupling element 1 according to the invention. It is appreciated that a recess is formed in the sole 14 of the athletic shoe wherein a reaction bearing 16 is inserted form locking or pressed into the recess. In particular a complete enclosure of the reaction bearing 16 by the sole material facilitates a minimum heat exchange with an interior of the shoe which can even be improved by selecting an insulator material for the reaction beaning 16. Externally the reaction bearing 16 includes three fastening receivers 19 where the coupling element 1 arranged there above can be alternatively attached. Depending on the desired positioning of the coupling element 1, a forward, center or rear fastening receiver 19 is selected and the remaining two fastening receivers 19 are respectively terminated by a sealing device 17, respectively configured as a set screw made from an insulating material.

Initially the cleat 2 is placed onto the sole 14 in order to attach the coupling element 1 at the sole 14. The cleat 2 includes interlocking devices at a bottom side that engage the material of the sole 14 as soon as the locking device is tightened. The cleat 2 further includes a pass-through opening 3 with a circular inner contour that includes shoulders so that a shoulder 4 is formed that provides a contact area for an eccentrical rotatable element 5. Thus, the inner contour of the cleat 2 facilitates a support for the eccentrical rotatable element on the shoulder 4 of the cleat 2 while the eccentrical rotatable element terminates flush with its upper edge with the cleat 2 so that the eccentrical rotatable element does not protrude beyond a surface of the cleat 2.

The eccentrical rotatable element is supported freely rotatable in the pass-through opening 3 of the cleat 2 and includes a semi-open slotted hole 8, which extends from one edge beyond a center of the eccentrical rotatable element 5 in a plane of a recess 6 formed by the eccentrical rotatable element 5, wherein the recess 6 receives the shoulder 4. A longitudinal slot 7 is formed parallel to the longitudinal extension of the slotted hole 8 in the plane above the recess 6 wherein the longitudinal slot 7 forms a longitudinal guide for a slide element 9. The slide element 9 is displaceable in a linear manner along the longitudinal slot 7 to boundaries of the inner contour of the pass-through opening 3 of the cleat 2 and in turn includes an eccentrical pass through opening 10 which facilitates a positioning of an attachment bolt 11 from a center position to an edge position within the eccentrical rotatable element 5 and thus within the cleat 2. Thus, the attachment bolt 11 includes a shaft 13 which can be threaded into the fastening receiver 19 that is free from the sealing devices 17 so that the shaft 13 seals the fastening receiver 19 and provides a form locking connection of the cleat 2, the eccentrical rotatable element 5 and the sliding element 9 at the reaction bearing 16 with the sole 14 arranged there between. Before tightening the attachment bolt 11, a position of the coupling element 1 about the fastening receiver 19 and an angular orientation of the coupling element 1 can be determined at will by rotating the eccentrical rotatable element 5 in the pass-through opening 3 of the cleat 2 and by a longitudinal displacement of the sliding element 9 in the longitudinal slot 7 of the eccentrical rotatable element 5. Eventually the fastening bolt 11 is tightened so that the position of the coupling element is fixed.

FIG. 6 shows an embodiment of the invention after tightening the fastening bolt 11. It is appreciated that a head 12 of the fastening bolt 11 does not extend beyond a surface of the cleat 2 in this position so that a flush surface of the coupling element 1 is achieved, wherein flush means also being arranged below a level of the surface of the cleat. The embodiment according to FIG. 6 shows a conical protrusion 18 that is configured about each of the fastening receivers 19. It is evident that interlocking devices below the cleat 2 engage material of the sole 14 wherein this effect is more pronounced about the fastening receiver 19. This improves support on the surface of the sole 14 and simultaneously increases sealing about the fastening receiver.

Thus, a coupling element and an athletic shoe with the coupling element are described which combine good sealing and good insulation properties with a high level of flexibility of positioning and alignment of the cleat at the sole.

### REFERENCE NUMERALS AND DESIGNATIONS

1 coupling element
2 cleat
3 pass-through opening
4 shoulder
5 eccentrical rotatable element
6 recess
7 longitudinal slot
8 slotted hole
9 sliding element
10 pass-through opening
11 fastening bolt
12 head
13 shaft
14 sole athletic shoe
15 recess
16 reaction bearing
17 sealing device
18 protrusion
19 receiver

What is claimed is:

1. A coupling element configured to connect an athletic shoe with a piece of sports equipment, the coupling element comprising:
a cleat configured to engage the piece of sports equipment and disengage from the piece of sports equipment;
at least one fastener configured to fasten the cleat at a reaction bearing arranged in a sole of the athletic shoe,
wherein the cleat includes exactly one rotation symmetrical pass through opening configured to receive the at least one fastener,
wherein the exactly one rotation symmetrical pass-through opening includes at least one concentric shoulder that cooperates with an eccentrical rotatable element that is inserted in the pass-through opening in a form locking manner, includes a recess configured to receive the at least one concentric shoulder in a form locking manner, and that terminates flush with a surface of the cleat,
wherein the at least one fastener includes exactly one fastening bolt that includes a head that terminates flush with the surface of the cleat in an operating condition.

2. A coupling element configured to connect an athletic shoe with a piece of sports equipment, the coupling element comprising:
a cleat configured to engage the piece of sports equipment and disengage from the piece of sports equipment,
at least one fastener configured to fasten the cleat at a reaction bearing arranged in a sole of the athletic shoe,
wherein the cleat includes exactly one rotation symmetrical pass through opening configured to receive the at least one fastener,
wherein the exactly one rotation symmetrical pass-through opening includes at least one concentric shoulder that cooperates with an eccentrical rotatable element that is inserted in the pass-through opening in a form locking manner, includes a recess configured to receive the at least one concentric shoulder in a form locking manner, and that terminates flush with a surface of the cleat,
wherein the eccentrical rotatable element includes a longitudinal slot arranged above the recess and configured to receive a sliding plate, and
wherein the eccentrical rotatable element includes a half open or closed slotted hole in a plane of the recess wherein edges of the half open or closed slotted hole protrude relative to lateral walls of the longitudinal slot.

3. The coupling element according to claim 2,
wherein the sliding plate is inserted into the longitudinal slot, and
wherein the sliding plate includes an eccentrically arranged pass-through opening configured to receive the at least one fastener.

4. A coupling element configured to connect an athletic shoe with a piece of sports equipment, the coupling element comprising:
a cleat configured to engage the piece of sports equipment and disengage from the piece of sports equipment;
at least one fastener configured to fasten the cleat at a reaction bearing arranged in a sole of the athletic shoe,
wherein the cleat includes exactly one rotation symmetrical pass through opening configured to receive the at least one fastener,
wherein the exactly one rotation symmetrical pass-through opening includes at least one concentric shoulder that cooperates with an eccentrical rotatable element that is inserted in the pass-through opening in a form locking manner, includes a recess configured to receive the at least one concentric shoulder in a form locking manner, and that terminates flush with a surface of the cleat,
wherein the eccentrical rotatable element includes a receiver for a circular sliding plate above the recess, and
wherein the receiver is circular and eccentrical with respect to the eccentrical rotatable element and at least partially enveloped by a circular segment shaped wall.

5. The coupling element according to claim 4,
wherein a circular sliding plate is inserted into the receiver, and
wherein the circular sliding plate includes an eccentrical pass-through opening configured to receive the at least one fastener.

6. The coupling element according to claim 2,
wherein the at least one fastener includes exactly one fastening bolt, and
wherein a head of the exactly one fastening bolt terminates flush with a surface of the cleat in an operating condition.

7. An athletic shoe, comprising:
a coupling element according to claim 1;
a sole, and
a reaction bearing associated with the sole and including at least one receiver configured for form locking reception of a shaft of the exactly one fastening bolt.

8. The athletic shoe according to claim 7,
wherein plural receivers are associated with the reaction bearing, and wherein
unused receivers of the plural receivers are closed by sealing devices.

9. The athletic shoe according to claim 7, wherein the reaction bearing is inserted without clearance into a recess of the sole or encased by a material of the sole by injection molding so that the plural receivers are accessible from a bottom of the sole.

10. The athletic shoe according to claim 7, wherein a protrusion is arranged about the at least one receiver of the reaction bearing so that the protrusion forms a conical contact area for the cleat at the sole.

11. The athletic shoe according to claim 7, wherein the reaction bearing is configured as a thermal insulator.
